(19) United States
(12) Patent Application Publication
(10) Pub. No.: US 2015/0028787 A1
(43) Pub. Date: Jan. 29, 2015

(54) CONVEYANCE CART

(71) Applicant: KAYABA INDUSTRY CO., LTD., Tokyo (JP)

(72) Inventors: Shinichi Sekine, Saitana (JP); Osamu Miyatani, Gifu (JP)

(73) Assignee: KAYABA INDUSTRY CO., LTD., Tokyo (JP)

(21) Appl. No.: 14/383,994

(22) PCT Filed: Mar. 7, 2013
(86) PCT No.: PCT/JP2013/056327

§ 371 Date: Sep. 9, 2014

(30) Foreign Application Priority Data
Mar. 15, 2012 (JP) 2012-059445

(51) Int. Cl. H02P 7/29

(52) U.S. Cl. CPC H02P 7/29; H02P 2007/622
USPC 318/494

(57) ABSTRACT

A conveyance cart includes: a body frame; a deck provided liftably against the body frame to load a burden; an electric actuator electrically driven to expand or contract to lift or lower the deck; a current detection element that detects an electric current value supplied to the electric actuator; and a PWM control element that drives the electric actuator in a pulse width modulation (PWM) control manner. The PWM control element increases an on-duty ratio input to the electric actuator if the electric current value detected by the current detection element exceeds a setting value when the deck is lifted.

### TECHNICAL FIELD

The present invention relates to a conveyance cart that can convey a loaded burden.

### BACKGROUND ART

In general, in order to convey a heavy burden in a factory or the like, a conveyance cart that can move in a loaded state is employed.

In JP2004-35239A, there is disclosed a movable lift unit that can lift a product loaded on a liftable deck up to a predetermined height. In this lift unit, the liftable deck is lifted or lowered by driving a motor.

### SUMMARY OF INVENTION

However, in the lift unit disclosed in JP2004-35239A, a driving force of the motor is constant when the liftable deck is lifted or lowered. For this reason, the motor is driven at the same driving force in both the cases of heavy and lights loads.

In view of the problems described above, it is therefore an object of this invention to suppress power consumption when the deck is lifted or lowered.

According to one aspect of this invention, a conveyance cart that can convey a loaded burden, includes a body frame supported by a wheel, a deck provided liftably against the body frame to load a burden; an electric actuator electrically driven to expand or contract to lift or lower the deck, a current detection element that is configured to detect an electric current value supplied to the electric actuator, and a PWM control element that is configured to drive the electric actuator in a pulse width modulation (PWM) control manner. The PWM control element increases an on-duty ratio input to the electric actuator if the electric current value detected by the current detection element exceeds a setting value when the deck is lifted.

The details as well as other features and advantages of this invention are set forth in the remainder of the specification and are shown in the accompanying drawings.

### BRIEF DESCRIPTION OF DRAWINGS

FIG. 1 is a side view illustrating a state that a deck of a conveyance cart according to an embodiment of this disclosure stays at a descending end;

FIG. 2 is a front view of FIG. 1;

FIG. 3 is a rear view of FIG. 1;

FIG. 4 is a control block diagram of the conveyance cart according to an embodiment of this disclosure;

FIG. 5 is a side view illustrating a state that the deck of the conveyance cart according to an embodiment of this disclosure stays at an ascending end; and

FIG. 6 is a flowchart illustrating a deck ascending operation in the conveyance cart according to an embodiment of this disclosure.

### DESCRIPTION OF EMBODIMENTS

Hereinafter, a conveyance cart 100 according to an embodiment of this disclosure will be described with reference to the accompanying drawings.

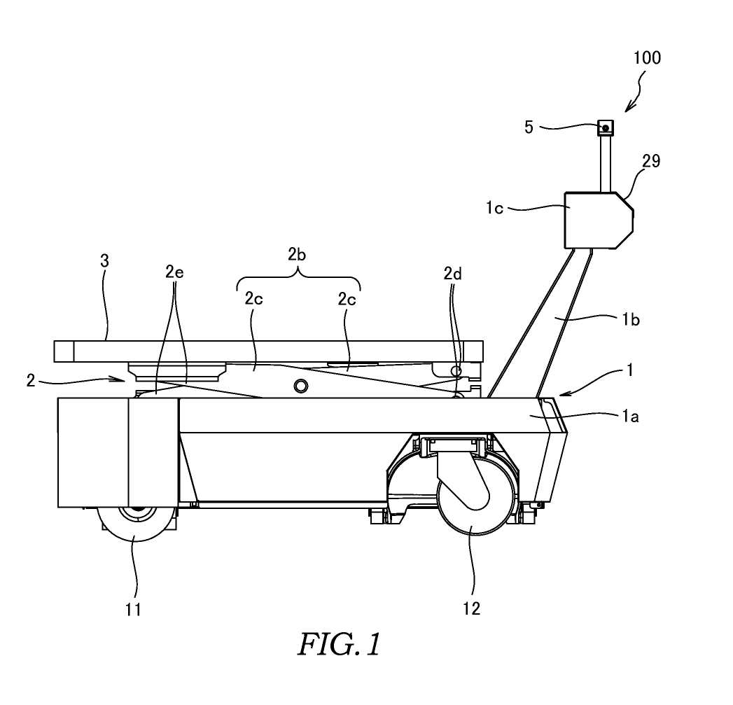

First, a configuration of the conveyance cart 100 according to an embodiment of this disclosure will be described with reference to FIGS. 1 to 5.

The conveyance cart 100 is used to carry a loaded burden, for example, in a factory or the like. The conveyance cart 100 travels by virtue of an assisting force caused by rotation of an electric motor 15 described below in addition to a driving force applied from an operator. Although the conveyance cart 100 is described as a conveyance cart having an electric assist function herein, a typical manual cart having no electric assist function may also be employed.

The conveyance cart 100 includes a body frame 1, a deck 3 provided liftably against the body frame 1 to load a burden, a control handle 5 as a handling portion by which a driving force can be input from both left and right portions of the body frame 1, a pair of drive wheels 11 provided in both left and right sides of the body frame 1 with an interval, and a pair of universal wheels 12 installed in the body frame 1 in rear of the drive wheels 11. The drive wheels 11 are front wheels of the conveyance cart 100, and the universal wheels 12 are rear wheels of the conveyance cart 100. The drive wheels 11 and the universal wheels 12 serve as cart wheels.

The body frame 1 is supported by the drive wheels 11 and the universal wheels 12. The body frame 1 includes a planar portion 1a where a burden is loaded using a deck 3, a pair of erected portions 1b that are erected with a slope backward from an upper portion of the rear end of the planar portion 1a, and a control box 1c provided to connect upper ends of the pair of erected portions 1b.

The deck 3 is a flat plate provided to cover the top of the planar portion 1a of the body frame 1. A burden is directly loaded on the deck 3. A lift unit 2 is provided between the body frame 1 and the deck 3. The lift unit 2 will be described below in detail together with a lift mechanism of the deck 3.

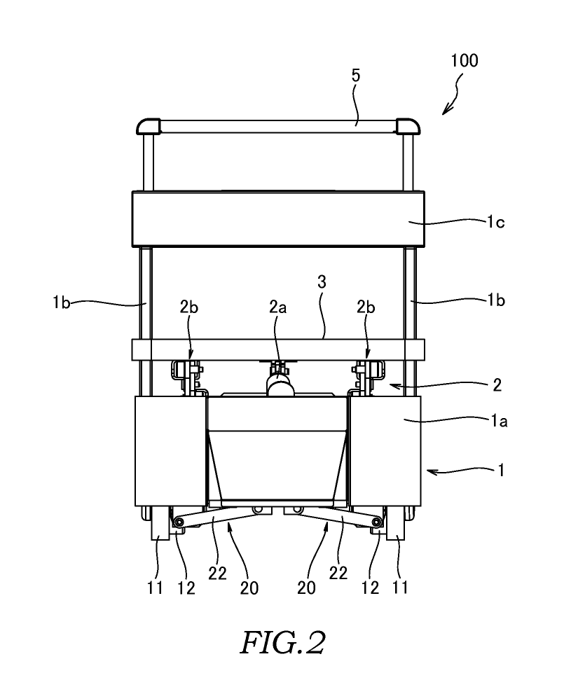

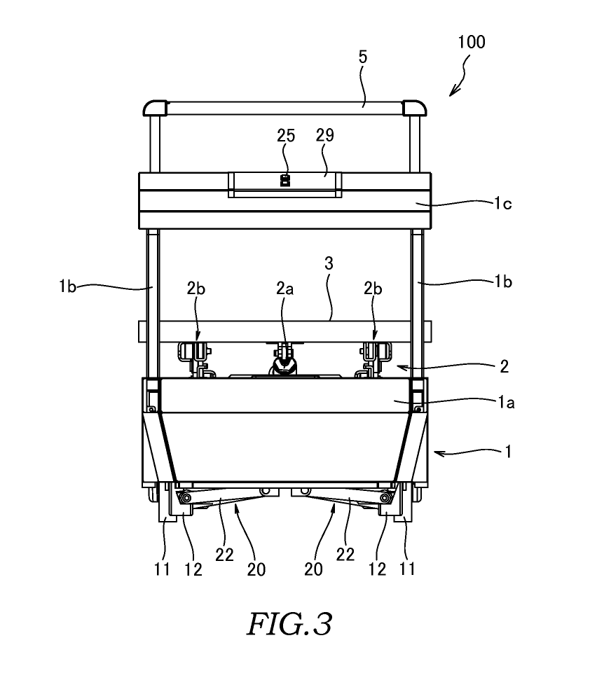

The control handle 5 is a reverse U-shaped handle pushed and handled by an operator as illustrated in FIGS. 2 and 3. Both left and right ends of the control handle 5 are connected to the control box 1c of the body frame 1. As a result, a driving force input when an operator handles the control handle 5 is transmitted to the body frame 1.

The drive wheel 11 is a small wheel provided unturnably in a longitudinal direction of the body frame 1. A pair of left and right drive wheels 11 are provided in the vicinity of the front end of the body frame 1. The drive wheels 11 are fixed to the body frame 1 movably upward and downward.

The universal wheel 12 is a small wheel directed to a movement direction at all times when the cart travels. The universal wheel 12 turns by a frictional resistance with the road surface to steer the cart toward a movement direction. The universal wheel 12 is fixed to the body frame 1 movably upward and downward.

The conveyance cart 100 includes a suspension unit 20 that suspends the driving wheels 11 and the universal wheels 12 from the body frame 1 as illustrated in FIGS. 2 and 3.

The suspension unit 20 includes a suspension arm 22 that supports the drive wheel 11 and the universal wheel 12 to the body frame 1 movably upward and downward and a spring damper (not illustrated) that dampens the up/down movement of the drive wheel 11 and the universal wheel 12. As a result, it is possible to alleviate up/down vibration of the drive wheel 11 and the universal wheel 12 caused by an uneven road surface and suppress vibration from the road surface from being transmitted to the body frame 1.

Next, an electric assist function of the conveyance cart 100 will be described.

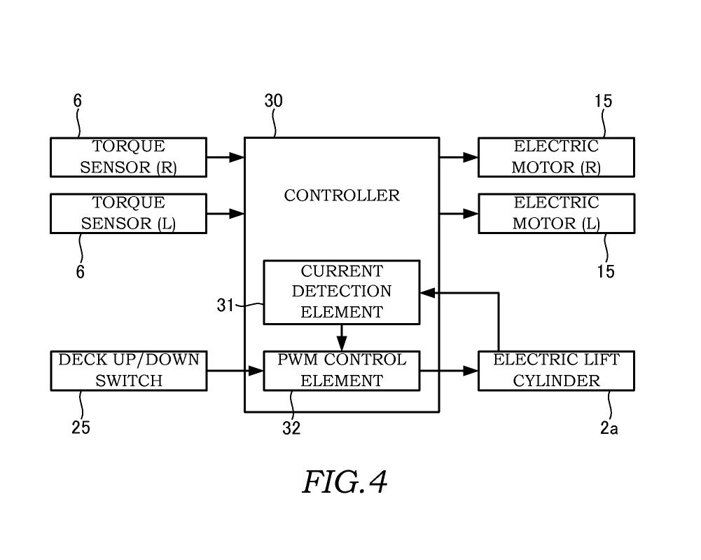

As illustrated in FIG. 4, the conveyance cart 100 includes a pair of torque sensors 6 as a pair of torque detectors for detecting a driving torque applied to each of the left and right portions of the body frame 1 as the control handle 5 is pushed and handled, a controller 30 as a control unit that computes an assisting force applied to each of the drive wheels 11 based on the driving torque detected by the torque sensor 6, and a pair of electric motors 15 that apply the assisting force computed by the controller 30 to each of the drive wheels 11.

The torque sensor 6 is housed in the control box 1c of the body frame 1. The torque sensor 6 is electrically connected to the controller 30 to output an electric signal corresponding to the detected driving torque to the controller 30.

The electric motor 15 is electrically connected to the controller 30 and rotates in response to an electric signal input from the controller 30. The electric motor 15 is provided in the inside of the drive wheel 11. The electric motor 15 applies an assisting force to the drive wheel 11.

The controller 30 is mounted on the body frame 1 along with a power supply (not illustrated) or other electronic devices (not illustrated). The controller 30 controls the conveyance cart 100 and is a microcomputer having a central processing unit (CPU), a read-only memory (ROM), a random access memory (RAM), and an input/output (I/O) interface. The RAM stores data for the processing of the CPU, and the ROM stores a control program or the like of the CPU in advance. The I/O interface is used to input/output information from/to a connected device. The control of the electric assist cart 100 is implemented by operating the CPU or the RAM based on the program stored in the ROM.

The controller 30 performs a control for generating the assisting force in each of the left and right electric motors 15 based on the driving force detected by the left and right torque sensors 6 to move the conveyance cart 100 forward or backward and apply an assisting force in a straight movement, a turning movement, and a curve movement.

Next, a driving operation of the conveyance cart 100 will be described.

When an operator pushes the control handle 5 with both hands in parallel, the conveyance cart 100 moves forward straightly. In this case, the driving force input to the body frame 1 by pushing the control handle 5 is approximately equal between the left and right sides of the control handle 5. Therefore, the driving torques detected by the left and right torque sensors 6 are also approximately equal to each other.

If the left and right torque sensors 6 detect the equal driving torque, the controller 30 instructs that the assisting force is equally applied to the left and right driving wheels 11 from the left and right electric motors 15. As a result, the assisting force is equally applied to the left and right drive wheels 11.

Therefore, the conveyance cart 100 moves forward straightly by virtue of the assisting force of the electric motor 15 in addition to the driving force applied by an operator.

When the conveyance cart 100 moves backward straightly, the pushing direction of the control handle 5 and the rotation direction of the electric motor 15 are reversed, and other actions are similar to those of the case where the conveyance cart 100 moves forward straightly.

Meanwhile, when an operator applies the pushing force to the control handle 5 differently between the left and right sides, the conveyance cart 100 turns left or right. In this case, the assisting force is differently applied to the left and right drive wheels 11 from the left and right electric motors 15.

Specifically, for example, when the conveyance cart 100 turns left, the pushing force applied to the control handle 5 by a right hand of an operator is stronger than the pushing force applied to the control handle 5 by a left hand of an operator. Therefore, the driving torque detected by the right torque sensor 6 is higher than the driving torque detected by the left torque sensor 6.

As a result, the controller 30 instructs that the assisting force applied from the right electric motor 15 to the drive wheel 11 is stronger than the assisting force applied from the left electric motor 15 to the drive wheel 11. As a result, the assisting force applied to the right drive wheel 11 becomes stronger than the assisting force applied to the left drive wheel 11.

It is noted that the magnitude of the assisting force can be controlled depending on the pushing force applied by an operator to the control handle 5 because the left and right torque sensors 6 can detect the driving force steplessly.

Next, a lift mechanism of the deck 3 of the conveyance cart 100 will be described.

The conveyance cart 100 includes a lift unit 2 that lifts or lowers the deck 3 against the body frame 1 and a console 29 provided with various switches that can be manipulated by an operator.

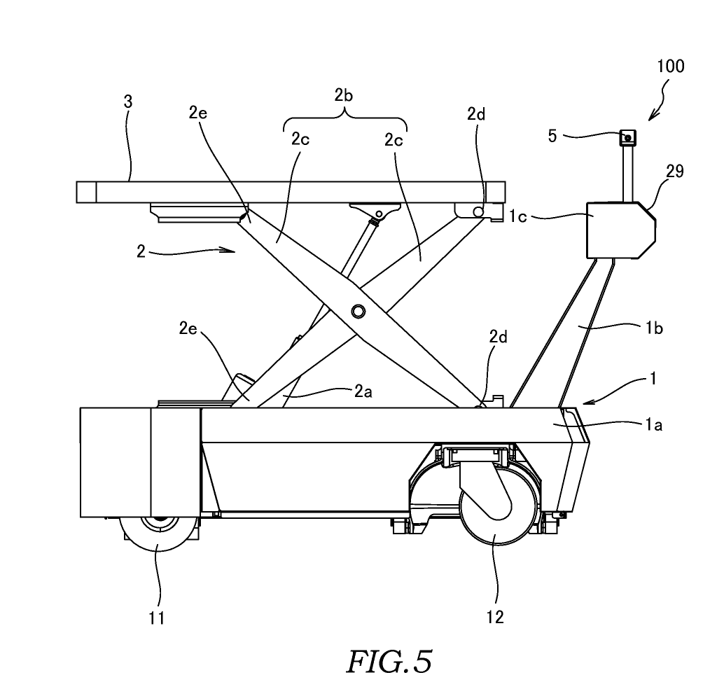

The lift unit 2 has an electric lift cylinder 2a (refer to FIG. 5) as an electric actuator that expands or contracts using electric power to lift or lower the deck 3 and a pair of left and right link mechanisms 2b that guide the deck 3 in parallel with the planar portion 1a of the body frame 1 when the deck 3 is lifted or lowered.

The lift unit 2 lifts or lowers the deck 3 by causing the electric lift cylinder 2a to expand or contract. For example, when a heavy burden is loaded on the deck 3, and the body frame 1 sinks to the drive wheel 11 and the universal wheel 12 by means of the suspension unit 20, the lift unit 2 may lift the deck 3 to constantly maintain a height of the deck 3 from the road surface.

The electric lift cylinder 2a is electrically connected to the controller 30 and expands or contracts in response to an electric current supplied based on the instruction signal from the controller 30. The electric lift cylinder 2a is an electric hydraulic linear actuator provided with a hydraulic pump driven by a motor so as to expand or contract by virtue of a pressure of the hydraulic fluid discharged from the hydraulic pump. Instead of the electric lift cylinder 2a, other types of electric actuators such as a ball screw type or a linear motor type may also be employed.

The link mechanism 2b is an X-shaped link having a pair of link arms 2c crossing in the X-shape. One end 2d of the link arm 2c is pivotably fixed to an upper portion of the body frame 1 or a lower portion of the deck 3, and the other end 2e slidably abuts on an upper portion of the body frame 1 or a lower portion of the deck 3. A pair of link arms 2c are pivotably connected to each other approximately in a center of a longitudinal direction.

Similar to the electric lift cylinder 2a, the link arms 2c are substantially in a horizontal state when the deck 3 is positioned in the descending end (as illustrated in FIG. 1). As the deck 3 is lifted, an angle of link arm 2c increases and becomes nearly vertical when it is fully stretched (as illustrated in FIG. 5).

The console 29 is arranged on the rear face of the control box 1c of the body frame 1 as illustrated in FIG. 3 and is electrically connected to the controller 30. The position of the console 29 is not particularly limited if the console 29 is provided in a position where an operator can manipulate and see it. The console 29 has a deck up/down switch 25 for controlling expansion and contraction of the electric lift cylinder 2a.

The deck up/down switch 25 is a switch for operating the electric lift cylinder 2a in response to an operator's manipulation. As an operator manipulates the deck up/down switch 25, the controller 30 instructs a driving electric current to flow to the electric lift cylinder 2a so that the electric lift cylinder 2a expands or contracts. As a result, the deck 3 is lifted or lowered against the body frame 1.

The controller 30, as illustrated in FIG. 4, includes a current detection element 31 that detects an electric current value supplied to the electric lift cylinder 2a and a PWM control element 32 that drives the electric lift cylinder 2a in a pulse width modulation (PWM) control manner. Although both the electric assist control and the deck up/down control are performed using a single controller 30 in the conveyance cart 100, they can also be performed using separate controllers.

The current detection element 31 detects an electric current value that changes depending on a magnitude of the load during expansion/contraction of the electric lift cylinder 2a. The electric current value during expansion/contraction of the electric lift cylinder 2a increases depending on a weight of the burden loaded on the deck 3. Alternatively, the current detection element 31 provided in the controller 30 may also be installed separately from the controller 30.

The PWM control element 32 increases an on-duty ratio input to the electric lift cylinder 2a if the current value detected by the current detection element 31 exceeds a setting value when the deck 3 is lifted. The setting value in this case is set to an electric current value flowing when the burden loaded on the deck 3 has a predetermined weight. Specifically, assuming that a maximum payload of the burden loaded on the deck 3 is set to 500 kg, the setting value is set to an electric current value flowing when a weight of 100 kg and the like is loaded.

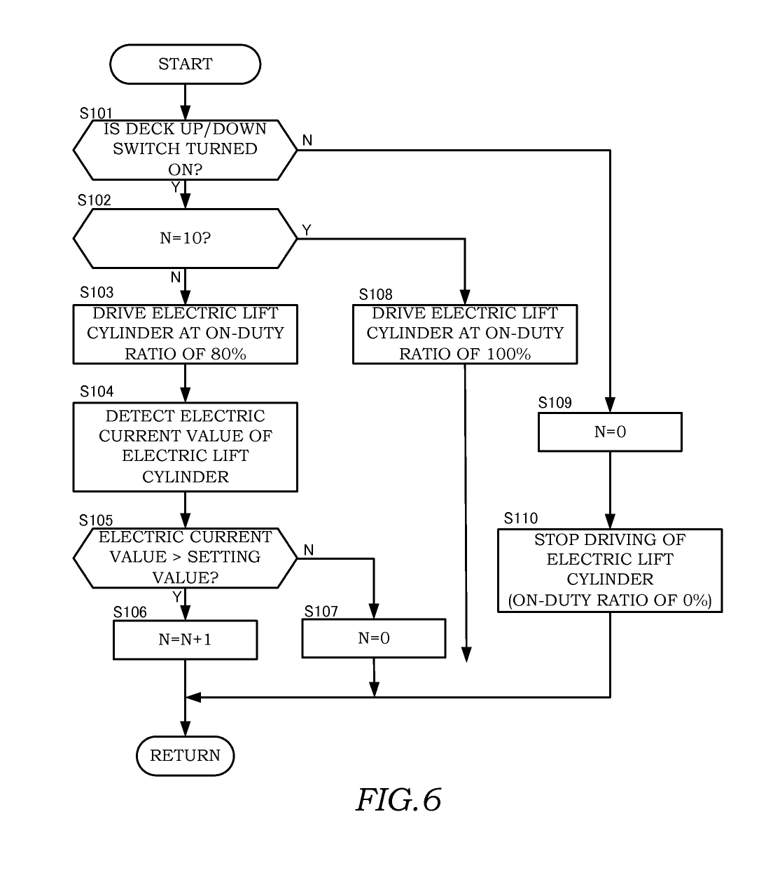

Next, a deck 3 lifting/lowering operation of the conveyance cart 100 will be described with reference to FIG. 6.

The flow of FIG. 6 starts when an operator manipulates the deck up/down switch 25 to lift the deck 3. For example, the flow of FIG. 6 is performed to lift the deck 3 from the descending end (as illustrated in FIG. 1) to the ascending end (as illustrated in FIG. 5) when the deck up/down switch 25 is manipulated. The controller 30 repeatedly performs this routine at a certain time interval, for example, every 10 millisecond.

In step S101, it is determined whether or not the deck up/down switch 25 is turned on. If it is determined that the deck up/down switch 25 is turned on in step S101, the process advances to step S102 because an operator manipulates the deck up/down switch 25. Otherwise, if it is determined that the deck up/down switch 25 is not turned on in step S101, the process advances to step S109 because an operator does not manipulate the deck up/down switch 25.

In step S102, it is determined whether or not a count of the number of times of determination that the electric current value exceeds a setting value in step S105 described below reaches a predetermined number. This predetermined number is set to a number by which erroneous determination influenced by noise and the like can be prevented. Here, the predetermined number is set to “10.” If it is determined that the count reaches the predetermined number, the process advances to step S108 because the burden loaded on the deck 3 is relatively heavy. Otherwise, if it is determined that the count does not reach the predetermined number in step S102, the process advances to step S103.

In step S103, the PWM control element 32 of the controller 30 drives the electric lift cylinder 2a at an on-duty ratio of 80%. The on-duty ratio of 80% corresponds to a first on-duty ratio.

Meanwhile, in step S108, the PWM control element 32 of the controller 30 drives the electric lift cylinder 2a by increasing the on-duty ratio input to the electric lift cylinder 2a to 100%. The on-duty ratio of 100% corresponds to a second on-duty ratio.

In this manner, the PWM control element 32 sets the on-duty ratio input to the electric lift cylinder 2a to the first on-duty ratio corresponding to 80% when the electric current value detected by the current detection element 31 is equal to or smaller than the setting value. Otherwise, if the electric current value detected by the current detection element 31 exceeds the setting value, the PWM control element 32 increases the on-duty ratio up to the second on-duty ratio of 100% greater than the first on-duty ratio.

In step S104, the current detection element 31 of the controller 30 detects the electric current value of the electric lift cylinder 2a. Since the electric current value of the electric lift cylinder 2a increases depending on a weight of the burden loaded on the deck 3, it is possible to indirectly detect the weight of the load by detecting the electric current value.

In step S105, it is determined whether or not the electric current value detected by the current detection element 31 exceeds a setting value. If it is determined that the detected electric current value exceeds the setting value in step S105, the process advances to step S106. Otherwise, if it is determined that the detected electric current value does not exceed the setting value in step S105, the process advances to step S107.

In step S106, the number of times that the electric current value periodically detected by the current detection element 31 exceeds the setting value in series is counted. Specifically, the count starts by setting N=0. If it is determined that the electric current value detected by the current detection element 31 exceeds the setting value in step S105, the count N is incremented (N=N+1). It is noted that the process advances to step S107, and the count N is reset to zero (N=0) if it is determined that the electric current value detected by the current detection element 31 is equal to or smaller than the setting value in step S105.

In step S109, the count N is reset to zero (N=0) because it is determined that the deck up/down switch 25 is not turned on in step S101, that is, it is determined that an operator does not manipulate the deck up/down switch 25. In addition, the process advances to step S110, and the driving operation stops by setting the on-duty ratio of the electric lift cylinder 2a to 0%.

As described above, if an electric current value supplied to the electric lift cylinder 2a exceeds the setting value when the deck 3 is lifted, the PWM control element 32 of the controller 30 increases the on-duty ratio input to the electric lift cylinder 2a from 80% to 100%. Therefore, the on-duty ratio increases to 100% only when the burden loaded on the deck 3 is relatively heavy. Meanwhile, the electric lift cylinder 2a is driven at the on-duty ratio of 80% when the burden loaded on the deck 3 is relatively light.

Therefore, since power consumption can be reduced when the burden loaded on the deck 3 is relatively light, it is possible to suppress power consumption when the deck 3 is lifted or lowered. In addition, by setting the on-duty ratio to 80% when the burden loaded on the deck 3 is relatively light, it is possible to suppress generation of noise caused by driving the electric lift cylinder 2a. Furthermore, since the expansion/contraction time period of the electric lift cylinder 2a can be reduced by setting the on-duty ratio to 100% when the burden loaded on the deck 3 is relatively heavy, it is possible to complete the lifting/lowering operation of the deck 3 within an allowed time period in an actual work.

Since the PWM control element 32 periodically repeats the control from step S101 to step S110, the PWM control element 32 counts the number of times that the electric current value periodically detected by the current detection element 31 exceeds the setting value in series. In addition, when the count reaches a predetermined number, the on-duty ratio input to the electric lift cylinder 2a increases. As a result, it is possible to prevent erroneous determination when the electric current value exceeding the setting value is detected singly due to influence from noise and the like.

It is noted that the PWM control element 32 drives the electric lift cylinder 2a at the on-duty ratio of 80% corresponding to the first on-duty ratio when the deck 3 is lowered.

According to the embodiments described above, it is possible to obtain the following effects.

If an electric current value supplied to the electric lift cylinder 2a exceeds the setting value when the deck 3 is lifted, the PWM control element 32 of the controller 30 increases the on-duty ratio input to the electric lift cylinder 2a from 80% to 100%. Accordingly, since the on-duty ratio increases to 100% only when the burden loaded on the deck 3 is relatively heavy, the electric lift cylinder 2a is driven at the on-duty ratio of 80% when the burden loaded on the deck 3 is relatively light. Accordingly, it is possible to reduce power consumption when the burden loaded on the deck 3 is relatively light and suppress power consumption when the deck 3 is lifted or lowered.

Embodiments of this invention were described above, but the above embodiments are merely examples of applications of this invention, and the technical scope of this invention is not limited to the specific constitutions of the above embodiments.

This application claims priority based on Japanese Patent Application No. 2012-059445 filed with the Japan Patent Office on Mar. 15, 2012, the entire contents of which are incorporated into this specification.

The embodiments of this invention in which an exclusive property or privilege is claimed are defined as follows:

1. A conveyance cart that can convey a loaded burden, comprising:
a body frame supported by a wheel;
a deck provided liftably against the body frame to load a burden;
an electric actuator electrically driven to expand or contract to lift or lower the deck;
a current detection element that is configured to detect an electric current value supplied to the electric actuator; and
a PWM control element that is configured to drive the electric actuator in a pulse width modulation (PWM) control manner,
wherein the PWM control element increases an on-duty ratio input to the electric actuator if the electric current value detected by the current detection element exceeds a setting value when the deck is lifted.

2. The conveyance cart according to claim 1, wherein the PWM control element counts the number of times that the electric current value periodically detected by the current detection element exceeds the setting value in series, and the on-duty ratio input to the electric actuator increases when the count exceeds a predetermined number.

3. The conveyance cart according to claim 1, wherein the setting value is set to an electric current value flowing when the burden loaded on the deck has a predetermined weight,
the PWM control element sets the on-duty ratio input to the electric actuator to a first on-duty ratio when the electric current value detected by the current detection element is equal to or smaller than the setting value, and
the PWM control element increases the on-duty ratio to a second on-duty ratio greater than the first on-duty ratio when the electric current value detected by the current detection element exceeds the setting value.

4. The conveyance cart according to claim 3, wherein the PWM control element drives the electric actuator at the first on-duty ratio when the deck is lowered.
